(19) United States
(12) Patent Application Publication
(10) Pub. No.: US 2024/0005144 A1
(43) Pub. Date: Jan. 4, 2024

(54) EFFICIENT MODEL FOR TRAINING A DEEP LEARNING ALGORITHM

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/852,703

(22) Filed: Jun. 29, 2022

(51) Int. Cl. G06N 3/08

(52) U.S. Cl. CPC G06N 3/08

(57) ABSTRACT

A system may provide a method of training a deep learning (DL) model, comprising: running a first version of the DL model on a first hardware platform using a first input set; running a second version of the DL model on a second hardware platform using the first input set, comprising imperfectly emulating the first hardware platform on the second hardware platform; computing an adjustment based at least in part on a difference in results between the first version of the DL model and second version of the DL model; and training the DL model on the second hardware platform using the adjustment and a plurality of input sets.

### FIELD OF THE SPECIFICATION

This invention relates generally to autonomous vehicle (AV) infrastructure, and more particularly, though not exclusively, to efficient models for training a deep learning algorithm.

### BACKGROUND

Autonomous vehicles (AVs), also known as self-driving cars, driverless vehicles, and robotic vehicles, are vehicles that use multiple sensors to sense the environment and move without human input. Automation technology in the AVs enables the vehicles to drive on roadways and to perceive the vehicle's environment accurately and quickly, including obstacles, signs, and traffic lights. The vehicles can be used to pick up passengers and drive the passengers to selected destinations. The vehicles can also be used to pick up packages and/or other goods and deliver the packages and/or goods to selected destinations.

### SUMMARY

A system may include a method of training a deep learning (DL) model, comprising: running a first version of the DL model on a first hardware platform using a first input set; running a second version of the DL model on a second hardware platform using the first input set, comprising imperfectly emulating the first hardware platform on the second hardware platform; computing an adjustment based at least in part on a difference in results between the first version of the DL model and second version of the DL model; and training the DL model on the second hardware platform using the adjustment and a plurality of input sets.

### BRIEF DESCRIPTION OF THE DRAWINGS

The present disclosure is best understood from the following detailed description when read with the accompanying FIGURES. In accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a security ecosystem.

FIG. 2 is a block diagram of selected elements of an AV controller.

FIG. 3 is a block diagram of selected elements of a validation and training ecosystem.

FIG. 4 is a flowchart of a method of providing simulation accuracy calculations.

FIG. 5 is a flowchart of a method.

FIG. 6 is a block diagram of selected elements of a hardware platform.

FIG. 7 is a block diagram of selected elements of a network function virtualization (NFV) infrastructure.

FIG. 8 is a block diagram of selected elements of a containerization infrastructure.

FIG. 9 illustrates machine learning according to a “textbook” problem with real-world applications.

FIG. 10 is a flowchart of a method that may be used to train a neural network.

FIG. 11 is a flowchart of a method of using a neural network to classify an object.

FIG. 12 is a block diagram illustrating selected elements of an analyzer engine.

### DETAILED DESCRIPTION

Overview

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

The algorithms for operating an AV are generally too complicated to be hand-coded by a human programmer as a decision flowchart. The large number of stimuli that provide inputs to the AV controller via sensors and the large body of decisions that the AV controller may need to make may generally be prohibitive in scale. Rather, an AV controller may operate via an artificial intelligence algorithm, such as a neural network. Neural networks are a species of machine learning, and within that species, there is a sub species known as DL. In general usage, a DL model is defined as a neural network that has at least three layers, namely an input layer, an output layer, and at least one intermediate layer.

In an operational AV, a pre-trained DL model may be loaded into the AV controller, which may provide one or more control nodes. These control nodes may include a hardware platform with a memory and may be controlled by a processor. Because AVs may need to make real-time or near real-time decisions with the DL model, accounting for large input datasets, it may be desirable in at least some cases to use specialized hardware that is different from a general-purpose or generic central processing unit (CPU). The digital signal processor (DSP) may include specialized hardware that is particularly adapted to the DL problem, and in particular to the AV context. Such specialized DSPs may provide operational control of the AV with higher efficiency and lower power draw than would be required for a general-purpose CPU to perform a similar task.

One challenge in the use of such specialized DSPs is that the DL model needs to be tested/validated on a large dataset before it can be deployed for true autonomous operation in the AV. In some cases, it may be impractical to test/validate the DL model in real-world operational situations (e.g., by actually driving the AV on real roads). Not only may it be impractical to provide the DL model with the desired number of inputs, but operating the AV in such a context may not be practical until the DL model is already tested, validated, or verified.

Thus, it may be desirable to test/validate the DL model in a simulated environment wherein real or simulated sensor data can be provided to the DL model in a very large number of iterations that can be used to test, debug, and validate the DL model. Such simulated environments can replicate a vast number of driving miles without the impracticalities of operating an AV with a DL model that has not yet been fully tested/validated. Furthermore, even once the DL model is fully tested/validated and full autonomous operation has begun, simulated environments may be used to further refine, upgrade, and/or validate the model.

A difficulty that may be encountered in a simulated environment is the availability of the specialized DSP hardware platforms that are used in the actual AV deployments. Such specialized hardware may not be produced in the same numbers as more generic processing platforms. Thus, it may be cost prohibitive or impractical for the AV operator to provide enough of the specialized hardware platforms to adequately test/validate the DL model. In some cases, it may be economically feasible to retain a third-party artificial intelligence (AI) vendor to test/validate the DL model. Such third-party vendors may perform simulated runs in a generalized CPU hardware architecture on a generalized hardware platform, such as a cloud hardware platform. The DL model may be coded with some hardware platform independence, and thus it may be practical to run a similar version of the DL model on the generalized hardware architecture, but such generalized versions of the model will not be bitwise identical to the original version of the model that runs on the specialized hardware platform. The specialized DSP hardware platform may be emulated in generalized hardware, but in these cases, engineering practicalities may come into play. It is possible and even feasible to produce a bitwise accurate model of the specialized DSP hardware platform in emulation on a generalized cloud hardware platform. Such a bitwise accurate model may emulate the hardware platform, the timing, all available inputs and outputs, and every other factor, even to include environmental factors, with complete or near complete fidelity. The purpose of such a bitwise accurate model is to produce a one-to-one correlation between the emulated model and the real-world specialized hardware platform. Given the same inputs, the emulated model should produce the exact same outputs as the real-world specialized DSP platform.

While such bitwise accurate modeling is feasible, it is not always practical from a computing cost and resources perspective. Providing absolute bitwise fidelity for the DL model may be time-consuming and expensive in terms of computer resources, which translates to monetary expenses. Because of the large volume of simulations that may need to be run, it may not be fiscally practical or practical from a resource availability perspective to provide absolute bitwise fidelity for every model. Furthermore, providing absolute bitwise fidelity consumes large quantities of energy and may thus contribute to environmental harm and/or contribute to climate change.

As a practical matter, it may be necessary to perform at least some testing/validation runs of the DL model in an emulated environment that is not absolutely bitwise perfect but that is “good enough” for the purposes at hand. In some cases, emulated models of the real-world specialized hardware platform environment may be provided at various levels of emulation fidelity. At the high end, there may be a high-fidelity model up to and including a bitwise accurate model. This model may be expected to consume the greatest amount of energy, compute resources, and money. Additional models may also be provided at various levels of fidelity, with lower levels of fidelity generally corresponding to lower costs in terms of energy, compute resources, and money.

A plurality of factors may be present in selecting a preferred fidelity for the simulated hardware environment. A first factor may be searching for a model that provides a preferred trade-off between cost and emulation fidelity. This trade-off may not be a static decision that is made once and locked in. Rather, the prices of compute resources in a cloud environment may vary over time depending on factors such as time of day, available resource loads, use of premium hardware, current peak load, and other factors. When accounting for all of these factors, the cost of various computer resources in a cloud platform may swing up and down similar to a stock market. Thus, the logic used to select a preferred fidelity may need to be adaptable enough to iteratively evaluate the desirability of using a particular fidelity model in context of the real-world, present-state compute costs. For example, at times when compute resources are relatively inexpensive, it may be preferable to use a relatively higher fidelity model. At times when computer resources are relatively more expensive, it may be preferable to use a relatively lower fidelity model. A second factor to consider is correcting for the fidelity of the model. The use of models with less than perfect emulation of the real-world platform may result in inaccuracies or inconsistencies in the testing/validation. If corrections are not made for these variances in the data, then the tests/validations may not provide the safety correspondence required for the real-world DSP platform. Thus, another factor to consider is correcting for inaccuracies in the lesser fidelity models. For example, a particular model may be efficient in terms of compute resources but may generally skew consistently to one side or another (e.g., too high or too low). If the skew alternates almost evenly between too high and too low, then the inaccuracies in the model may generally balance themselves out. But if the model skews consistently or in the majority to one side or the other, then this may introduce inaccuracies into the real-world version of the DL model. Thus, another aspect of selecting a model with less than absolute perfect fidelity is to calculate a correction for the selected model.

In one example, a relatively large number of runs (e.g., 100 or more simulated runs) may be performed on the actual DSP hardware platform or on an emulation that is bitwise accurate to the real-world platform. The same runs with the same inputs may be run on the lower fidelity or “efficient” version of the DSP model, such as in a cloud platform. As described above, the efficient model may have been selected with the fidelity level that is commensurate with the current state of the compute resource costs. After both versions of the model have been run, the outputs from the two versions can be compared to determine if the efficient model has produced outputs that have consistently or in the majority skewed to one side or the other. If the efficient model has skewed the results, then a correction factor or coefficient may be computed for the particular efficient model and can then be applied to the outputs of the efficient model to normalize those outputs to expected values provided by the real-world hardware platform or a bitwise accurate model. This results in test/validation results and a model that are useful for and accurate to the specialized hardware platform.

The correction factor may also be used to further evaluate the utility of the efficient model. For example, if the correction factor is greater than a threshold, then the model may be rejected as being too low fidelity to provide high confidence. In that case, an efficient model with higher fidelity may be selected. The procedures described above can be performed iteratively to select a preferred efficient model and to compute an accurate correction factor for the selected efficient model.

The foregoing can be used to build or embody several example implementations, according to the teachings of the present specification. Some example implementations are included here as non-limiting illustrations of these teachings.

### DETAILED DESCRIPTION OF THE DRAWINGS

A system and method for providing an efficient model for training a DL algorithm will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

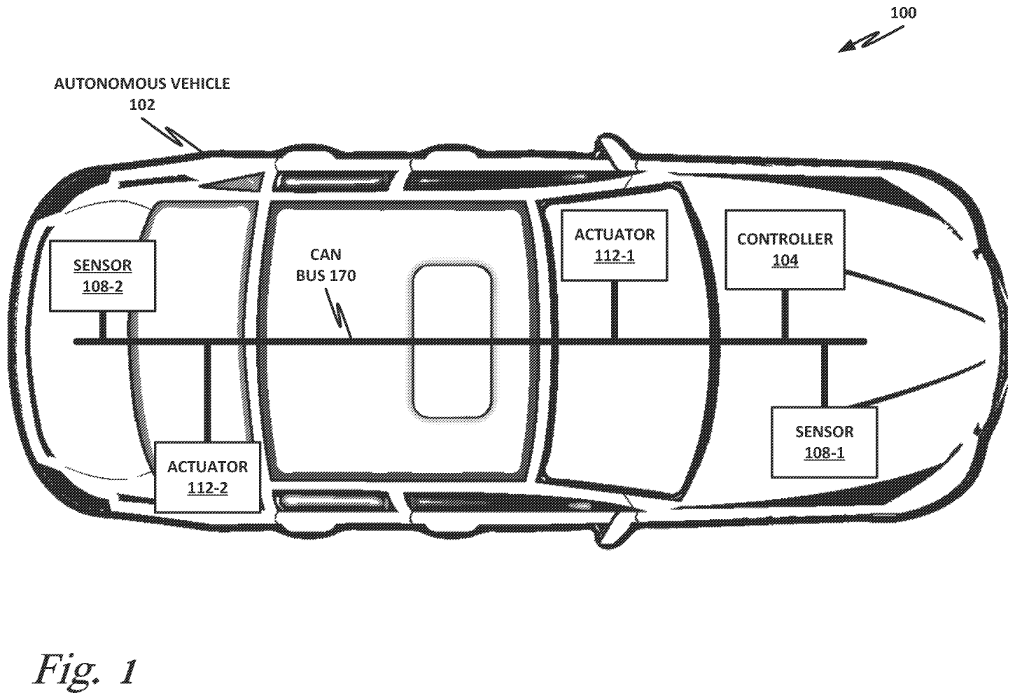

FIG. 1 is a block diagram 100 illustrating an example AV 102. AV 102 may be, for example, an automobile, car, truck, bus, train, tram, funicular, lift, or similar. AV 102 could also be an autonomous aircraft (fixed wing, rotary, or tiltrotor), ship, watercraft, hover craft, hydrofoil, buggy, cart, golf cart, recreational vehicle, motorcycle, off-road vehicle, three- or four-wheel all-terrain vehicle, or any other vehicle. Except to the extent specifically enumerated in the appended claims, the present specification is not intended to be limited to a particular vehicle or vehicle configuration.

In this example, AV 102 includes one or more sensors, such as sensor 108-1 and sensor 108-2. Sensors 108 may include, by way of illustrative and non-limiting example, localization and driving sensors such as photodetectors, cameras, Radio Detection and Ranging (RADAR), Sound Navigation and Ranging (SONAR), Light Detection and Ranging (LIDAR), GPS, inertial measurement units (IMUS), synchros, accelerometers, microphones, strain gauges, pressure monitors, barometers, thermometers, altimeters, wheel speed sensors, computer vision systems, biometric sensors for operators and/or passengers, or other sensors. In some embodiments, sensors 108 may include cameras implemented using high-resolution imagers with fixed mounting and field of view. In further examples, sensors 108 may include LIDARs implemented using scanning LIDARs. Scanning LIDARs have a dynamically configurable field of view that provides a point-cloud of the region intended to scan. In still further examples, sensors 108 includes RADARs implemented using scanning RADARs with dynamically configurable field of view.

AV 102 may further include one or more actuators 112. Actuators 112 may be configured to receive signals and to carry out control functions on AV 102. Actuators may include switches, relays, or mechanical, electrical, pneumatic, hydraulic, or other devices that control the vehicle. In various embodiments, actuators 112 may include steering actuators that control the direction of AV 102, such as by turning a steering wheel, or controlling control surfaces on an air or watercraft. Actuators 112 may further control motor functions, such as an engine throttle, thrust vectors, or others. Actuators 112 may also include controllers for speed, such as an accelerator. Actuators 112 may further operate brakes, or braking surfaces. Actuators 112 may further control headlights, indicators, warnings, a car horn, cameras, or other systems or subsystems that affect the operation of AV 102.

A controller 104 may provide the main control logic for AV 102. Controller 104 is illustrated here as a single logical unit and may be implemented as a single device such as an electronic control module (ECM) or other. In various embodiments, one or more functions of controller 104 may be distributed across various physical devices, such as multiple ECMs, one or more hardware accelerators, AI circuits, or other.

Controller 104 may be configured to receive from one or more sensors 108 data to indicate the status or condition of AV 102, as well as the status or condition of certain ambient factors, such as traffic, pedestrians, traffic signs, signal lights, weather conditions, road conditions, or others. Based on these inputs, controller 104 may determine adjustments to be made to actuators 112. Controller 104 may determine adjustments based on heuristics, lookup tables, AI, pattern recognition, or other algorithms.

Various components of AV 102 may communicate with one another via a bus such as controller area network (CAN) bus 170. CAN bus 170 is provided as an illustrative embodiment, but other types of buses may be used, including wired, wireless, fiberoptic, infrared, WiFi, Bluetooth, dielectric waveguides, or other types of buses. Bus 170 may implement any suitable protocol. For example, in some cases bus 170 may use transmission control protocol (TCP) for connections that require error correction. In cases where the overhead of TCP is not preferred, bus 170 may use a one-directional protocol without error correction, such as user datagram protocol (UDP). Other protocols may also be used. Lower layers of bus 170 may be provided by protocols such as any of the family of institute of electrical and electronics engineers (IEEE) 802 family of communication protocols, including any version or subversion of 802.1 (higher layer local area network (LAN)), 802.2 (logical link control), 802.3 (Ethernet), 802.4 (token bus), 802.5 (token ring), 802.6 (metropolitan area network), 802.7 (broadband coaxial), 802.8 (fiber optics), 802.9 (integrated service LAN), 802.10 (interoperable LAN security), 802.11 (wireless LAN), 80.12 (100VG), 802.14 (cable modems), 802.15 (wireless personal area network, including Bluetooth), 802.16 (broadband wireless access), or 802.17 (resilient packet ring) by way of illustrative and non-limiting example. Non-IEEE and proprietary protocols may also be supported, such as for example, InfiniBand, FibreChannel, FibreChannel over Ethernet (FCoE), Omni-Path, Lightning bus, or others. Bus 170 may also enable controller 104, sensors 108, actuators 112, and other systems and subsystems of AV 102 to communicate with external hosts, such as internet-based hosts. In some cases, AV 102 may form a mesh or other cooperative network with other AVs, which may allow sharing of sensor data, control functions, processing ability, or other resources.

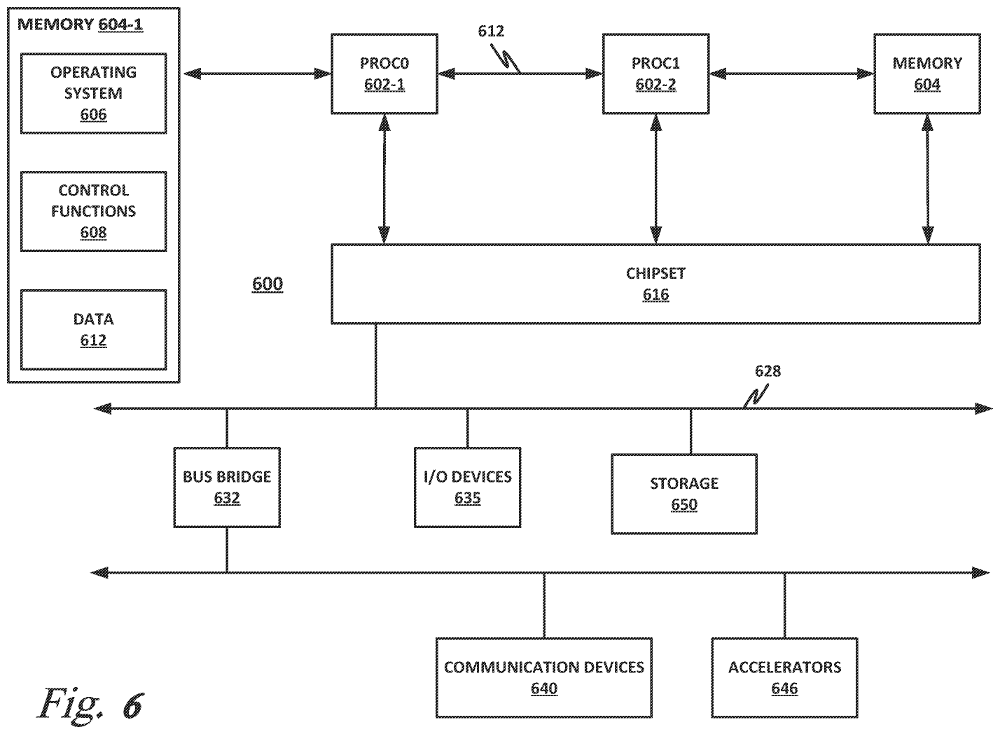

Controller 104 may control the operations and functionality of AVs 102, or one or more other AVs. Controller 104 may receive sensed data from sensors 108, and make onboard decisions based on the sensed data. In some cases, controller 104 may also offload some processing or decision making, such as to a cloud service or accelerator. In some cases, controller 104 is a general-purpose computer adapted for I/O communication with vehicle control systems and sensor systems. Controller 104 may be any suitable computing device. An illustration of a hardware platform is shown in FIG. 6, which may represent a suitable computing platform for controller 104. In some cases, controller 104 may be connected to the internet via a wireless connection (e.g., via a cellular data connection). In some examples, controller 104 is coupled to any number of wireless or wired communication systems. In some examples, controller 104 is coupled to one or more communication systems via a mesh network of devices, such as a mesh network formed by AVs.

According to various implementations, AV 102 may modify and/or set a driving behavior in response to parameters set by vehicle passengers (e.g., via a passenger interface) and/or other interested parties (e.g., via a vehicle coordinator or a remote expert interface). Driving behavior of an AV may be modified according to explicit input or feedback (e.g., a passenger specifying a maximum speed or a relative comfort level), implicit input or feedback (e.g., a passenger's heart rate), or any other suitable data or manner of communicating driving behavior preferences.

AV 102 is illustrated as a fully autonomous automobile but may additionally or alternatively be any semi-autonomous or fully autonomous vehicle. In some cases, AV 102 may switch between a semi-autonomous state and a fully autonomous state and thus, some AVs may have attributes of both a semi-autonomous vehicle and a fully autonomous vehicle depending on the state of the vehicle.

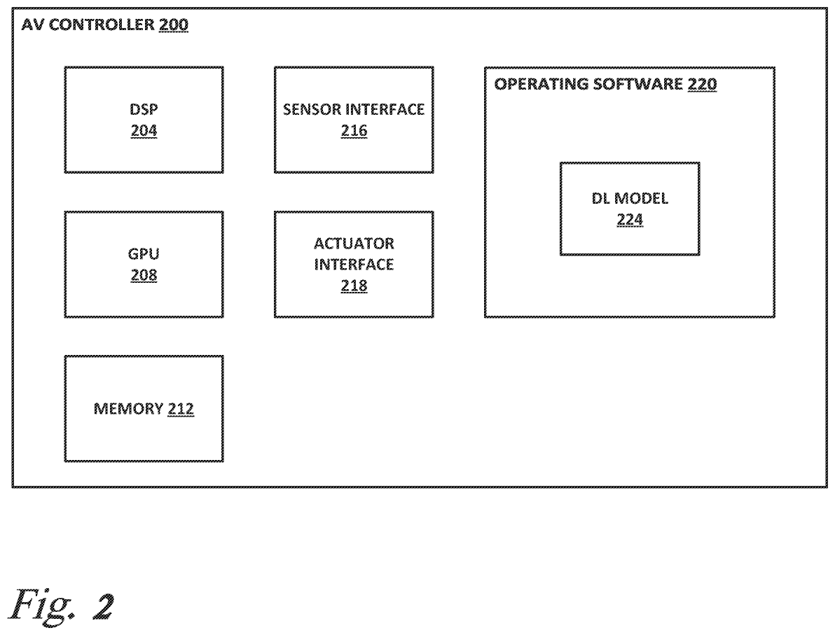

FIG. 2 is a block diagram of selected elements of an AV controller 200. AV controller 200 may be a hardware platform that is disposed to control an AV, which may operate, for example, in L4 or L4 plus mode wherein the AV operates completely autonomously. Alternatively, the AV may operate in a lesser mode, such as L1, L2, or L3.

AV controller 200 may be a unitary controller or it may be part of a set of redundant controllers, such as a set of four redundant controllers. This can ensure high availability for the AV controller 200.

AV controller 200 may include a DSP 204. DSP 204 may be any suitable processor, including a general-purpose microprocessor, a CPU, a DSP, a microcontroller, or similar. DSP 204 may also be provided by an application-specific integrated circuit (ASIC), a field-programmable gate array (FPGA), or other. In this example, DSP 204 is used as an illustration to stand for the entire class of processors that could be used to control AV controller 200.

In the case of an actual DSP, DSP 204 may include special-purpose hardware and other modifications that may adapt DSP 204 to be particularly useful in the AV context. Because of these modifications, DSP 204 may be available in lower volumes than general-purpose CPUs. For example, DSP 204 may include a machine learning (ML) accelerator that is optimized for efficient compute of ML workloads. DSP 204 may include of a highly custom and parallelized compute architecture such as a resistive cross-bar, indexed weights, or analog compute. DSP 204 may be more cost efficient and specialized compared to the compute provided by the graphics processing unit (GPU) 208, and as a result DSP 204 may be used for most typical workloads, while GPU 208 may be reserved for limited atypical functionality that cannot be performed by, or is less efficient on, DSP 204.

AV controller 200 may also include a GPU 208. GPU 208 may assist in computer vision operations, may run one or more machine learning ordeal models, and may drive displays for the operator of the vehicle.

Sensor interface 216 may be configured to interface with sensors, such as sensors 108 of FIG. 1.

AV controller 200 includes an actuator interface 218. This may be used to drive outputs to actuators to effect the control of the AV.

Memory 212 may include a general-purpose dynamic random access memory (DRAM) as well as other types of memory including various types of volatile and/or nonvolatile memory. Memory 212 may include any of the types of memory and storage illustrated in FIGURE QB below, or any other type of suitable memory.

AV controller 200 includes an operating software 220. Operating software 220 provides the software for controlling the AV and may include common elements, such as an operating system, a user interface, drivers, and other software libraries. Operating software 220 may also include a DL model 224. DL model 224 may be, for example, a neural network with at least three layers and may be used to make operational decisions for the AV. For example, DL model 224 may include various modules, such as a sensing module, a perception module, a prediction module, a planning module, and/or a control module.

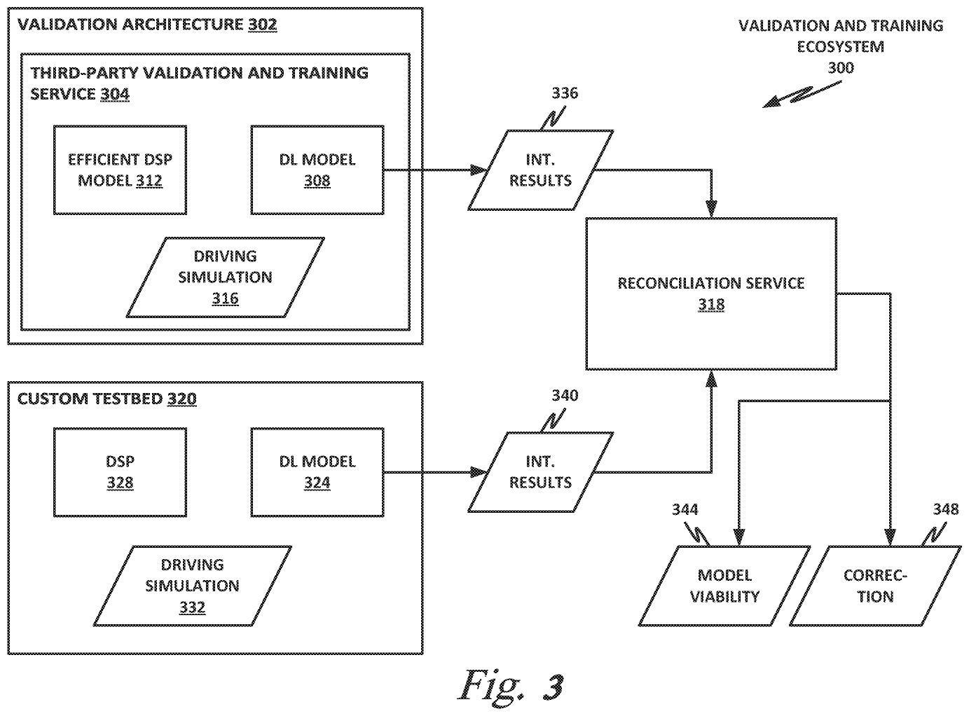

FIG. 3 is a block diagram of selected elements of a validation and training ecosystem 300. Validation and training ecosystem 300 may be used to train, validate, test, and otherwise improve a DL model, such as DL model 224 of FIG. 2. The DL model may be used to control an AV, and thus it may be advantageous to collect real-world test/validation run data, as well as to provide simulated test/validation runs that can be used to improve the DL model in high volume. In general, it may be possible to do a simulated test/validation run in much less time and using fewer resources than to do an actual trial run on a real road in a real vehicle.

Validation and training ecosystem 300 includes various components, such as a validation architecture 302, a custom testbed 320, and a reconciliation service 318. These services may be provided in different hardware and software platform configurations. In general terms, a first processor and memory configuration may be used to provide validation architecture 302, a second processor and memory configuration may be used to provide custom testbed 320, and a third processor and memory configuration may be used to provide reconciliation service 318. These various processor and memory configurations need not be exclusive of one another at a hardware level. For example, validation architecture 302 and reconciliation service 318 may commonly run on a cloud platform. In this case, the various modules may be provided as discrete virtual machines, containers, or other microservices or modules. These modules may run on the same or different hardware platforms. For example, a single compute platform may provide one or more processors and memory and may provide a plurality of virtual machines or containers. In other cases, different virtual machines and containers may be hosted on different physical hardware platforms. Thus, the concept of different processor and memory configurations should be understood to include either the same processor running different software or a different processor running different software.

A custom testbed 320 may include a hardware configuration that most closely correlates to the real AV, such as AV controller 200 of FIG. 2. Custom testbed 320 may include a DSP 328 that is an instance of the same DSP that runs on AV controller 200 of FIG. 2. Alternatively, custom testbed 320 may run on a cloud platform and may provide a bitwise accurate simulation of the custom DSP. From a training and validation perspective, as long as the emulated DSP is truly bitwise accurate to the real DSP, the bitwise accurate emulation and the real DSP can be considered to be equivalent. Custom testbed 320 provides a first version of a DL model 324, which runs on DSP 328. DL model 324 may be provided one or more driving simulations 332, which include real sensor inputs collected from real-world driving tests/validations, or simulated or modified sensor inputs. DL model 324 receives these inputs and, running driving simulation 332, produces intermediate results 340, which may include, for example, intermediate signals and safety which may be referred to as actual intermediate signals and safety, indicating that they were provided by DSP 328 or by a bitwise accurate model thereof.

Validation architecture 302 may include a cloud-based third-party validation and training service 304. Third-party validation and training service 304 may provide a more general-purpose hardware architecture, such as general-purpose CPUs. Although service 304 is referred to as a third-party validation and training service by way of illustrative example, it need not be provided by a third-party. In the case of a third-party, the operator of the AV infrastructure provides DL model 308 to the third-party training service, and the third-party training service uses one or more driving simulations 316 to test/validate DL model 308 on its platform. Because service 304 may not feasibly be provided with real examples of DSP 328, and because it may not be efficient to provide a bitwise accurate emulation of DSP 328, third-party validation and training service 304 may instead deploy an efficient DSP model 312. Efficient DSP model 312 is not bitwise accurate to DSP 328. Rather, it provides a more approximate model of DSP 328. More specifically, rather than attempting to model DSP 328 numerically or exactly, efficient DSP model 312 may be a statistical model that attempts to approximate the same result even if the internal workings are different. Efficient DSP model 312 may be provided with a model fidelity, which may be selected as one of several available model fidelities. The different fidelities of DSP models may provide different error tolerances and may also have different costs associated with them.

DL model 308 running on efficient DSP model 312 may provide a large number of driving simulations 316, which provide intermediate results 336. These may be referred to as cloud intermediate signals and safety. The cloud intermediate signals and safety data may be expected to be different from those of the actual intermediate signals and safety of block 340. Because the cloud intermediate results were produced by efficient DSP model 312, they may be generally skewed in one direction or another.

Reconciliation service 318 receives both intermediate results sets 336, 340. Reconciliation service 318 may include logic, such as software instructions, to compare intermediate results 336 to intermediate results 340. Reconciliation service 318 can then determine whether the model is viable. For example, if the error margin is outside of a threshold, then the model may be rejected, and it may be necessary to use a higher fidelity model to produce useful results. Thus, reconciliation service 318 may export model viability 344.

If the model is at least viable, or in other words, if it at least meets an error threshold, then reconciliation service 318 may also compute a delta between intermediate results 336 and intermediate results 340. This can be a statistical delta, which can show a trend to one direction or another. For example, the delta may include a sum of individual errors between specific values. Because DSP 328 and efficient DSP model 312 both used the same driving simulation data, the results of efficient DSP model 312 can be compared to the results of DSP 328 and the appropriate error correction can be computed. Thus, reconciliation service 318 may also export correction 348. Correction 348 may include a quantitative analysis of how the results from efficient DSP model 312—using the selected fidelity—should be adjusted to more nearly track the results that would have been provided by DSP 328 if it were provided with the same inputs.

This correction allows the third-party training service that operates cloud service 304 to then test/validate DL model 308 on a large number of driving simulations 316 using efficient DSP model 312. The results of these test/validation runs can then be corrected according to the known correction value 348 for the efficient DSP model 312 using the selected fidelity value. This enables the third-party validation and training service to more efficiently test/validate the DL model on general-purpose or generic hardware rather than having to perform all runs on the actual DSP 328 or on bitwise accurate models thereof.

Furthermore, reconciliation service 318 can iteratively monitor efficient DSP model 312 and the selected fidelity. Reconciliation service 318 may iteratively test/validate different fidelities and use a cost function to compute the cost of using a particular efficient DSP model 312 with a selected fidelity. Because the costs of compute resources and time may vary frequently, reconciliation service 318 may continuously update and improve the results to account for fluctuations in the cost of compute resources.

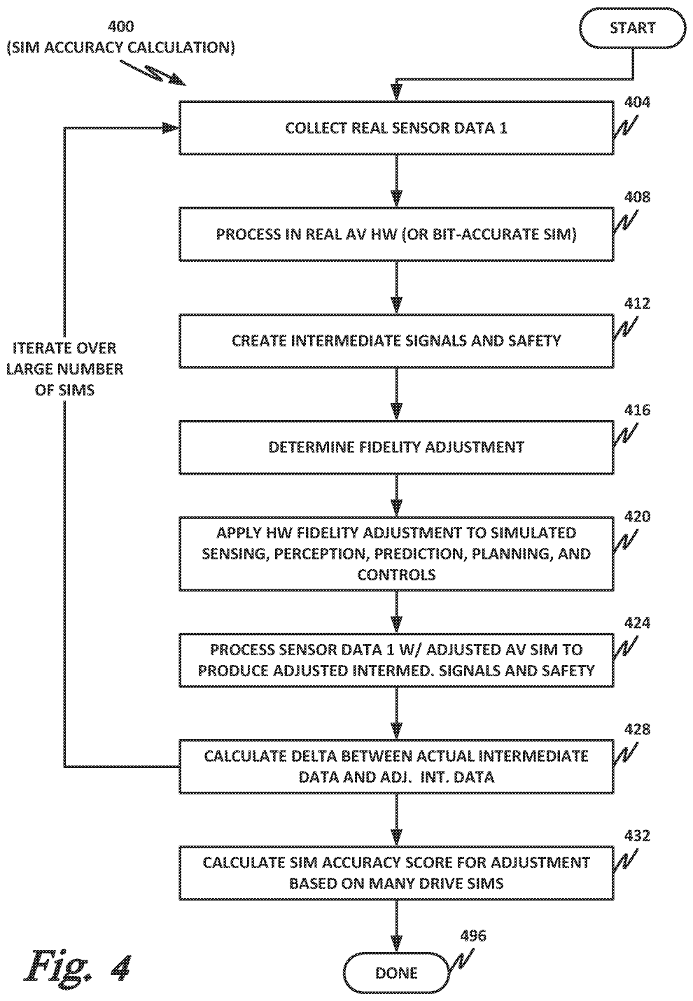

FIG. 4 is a flowchart of a method 400 of providing simulation accuracy calculations. Method 400 may be used to determine how accurate and efficient a DSP model is compared to the actual DSP.

In block 404, the AV collects real sensor data 1. This may include, for example, collecting sensor data from a real test run or data that were stored from a previous real test/validation run. Alternatively a very high-fidelity simulation may be used in the place of real sensor data 1.

In block 408, sensor 1 data may be processed using the actual AV hardware or a bitwise accurate simulation of the actual AV hardware. This produces the actual intermediate signals and safety data, which can be used in the subsequent steps as a reference for comparison and determination of accuracy. In some embodiments, in block 408, only a subset of the AV hardware may be used, while the rest of the hardware may be substituted by a different hardware or simulation. For example, pre-processing may be conducted on a different and cheaper bitwise accurate DSP, while perception, prediction, and planning may be conducted on the actual AV hardware.

In block 412, based on the simulation, the DSP creates the actual intermediate signals and safety data. The intermediate signals are the outputs of perception, prediction, planning and Controls or any other signal within these modules. Safety data may be a safety score, probability of a safety incident, comfort scores that indicate how comfortable the ride is (i.e. lack of sudden acceleration, deceleration, turns, etc.).

In block 416, the system may determine an adjustment to the hardware fidelity. The adjustment may comprise moving part of the computation between DSP, GPU, and CPU. The adjustment may comprise reducing or increasing the bit-width of the computation (for example, moving computation from floating point to integer, or vice-versa). The adjustment may comprise using a different ML model, which may be smaller or larger. The adjustment may comprise adjusting the maximum number of objects in perception, maximum number of objects or paths in prediction, the resolution of sensor data, or number of paths evaluated by planning by way of illustrative and non-limiting example. The adjustment may comprise using a deep learning (DL) model with more or fewer layers, channels or filters. For each type of adjustment, there may be multiple levels of adjustment that can be applied. For example, there could be three levels for number of layers: “double”, “normal”, “halved”.

In block 420, the system may apply the adjustment to hardware fidelity to the AV sensing, perception, prediction, planning, and controls simulation. To make the DL model robust to the adjustment, and to ensure that it can be accurately trained, tested, or validated on an efficient model, the system may inject noise that statistically mimics the discrepancies due to the adjustment such as custom hardware discrepancies that may be encountered with efficient AV models. For example, to simulate the effect of precision adjustment, noise that is of the same order of magnitude with the bit level of the lowest bit precision can be injected to mimic precision adjustment noise. The system may also inject a real or approximate model of the custom hardware. Thus, DL models may be replaced with more efficient ones that run on generic hardware and the system may use DL optimizations.

In block 424, the system processes sensor data 1 with the adjusted AV simulation to produce the adjusted intermediate signals and safety. This may include running a version of the DL model on a cloud platform (or other platform) using an efficient DL model.

In block 428, the system calculates a delta between the actual intermediate data and the adjusted intermediate signals and safety. The delta may be calculated by subtracting one from the other. For example, safety score from the actual intermediate data may be subtracted from the adjusted safety. Similarly, bounding box coordinates of the perceived objects may be subtracted from the bounding box coordinates of the adjusted perceived objects. This can be used to calculate an accuracy for the efficient model used at the specified simulation fidelity, as in block 432.

The system then iterates over a large number of simulations on a single efficient hardware model at a single fidelity value. The large number of simulations run on each efficient model can provide a statistically significant and reliable prediction of the fidelity of the model compared to a full bitwise accurate simulation or running the model on the true DSP hardware. The number of simulations may be on the order of 10,000 to 10,000,000.

In block 432, the system calculates the simulation accuracy score for adjustment based on many drive simulations. For example, the system may statistically compute an appropriate correction based on a large number of simulations run on the same efficient model with the same fidelity value.

In block 496, the method is done.

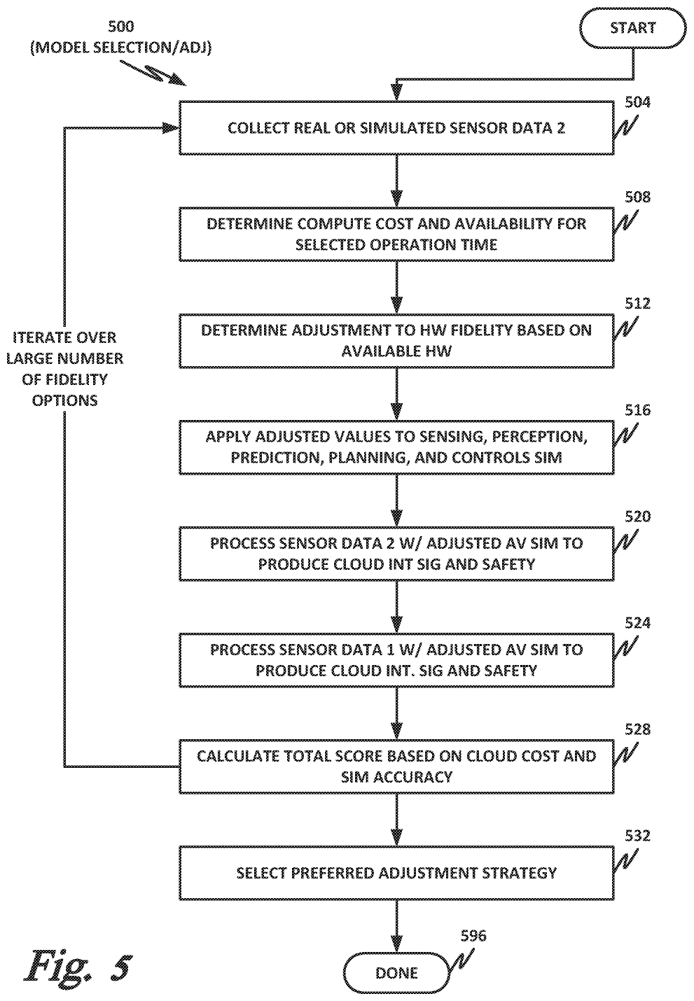

FIG. 5 is a flowchart of a method 500. Method 500 may be used for model selection and adjustment.

In block 504, the system collects real or simulated sensor data 2.

In block 508, the system may determine the compute cost and availability for a selected operation time. As noted above, cost and availability may vary depending on the time and external factors. For example, on a cloud platform, compute costs may vary depending on the number of current tenants using the platform, real-time power demands, real-time network loads, and other factors. Thus, the availability and cost of a particular efficient model running at a given fidelity may not stay the same over time. Rather, it may fluctuate up and down similar to a stock market.

In block 512, the system may determine an adjustment to the hardware fidelity based on available hardware and costs.

In block 516, the system may apply the adjusted values to sensing, perception, prediction, planning, and controls simulations. As before, the system may inject noise that statistically mimics the custom hardware discrepancies. The system may also inject real or approximate models of custom hardware. The system may replace DL models with more efficient ones on generic hardware, and the system may use appropriate DL optimizations.

In block 520, the system processes sensor data 2 with the adjusted AV simulation to produce cloud intermediate signals and safety. This yields intermediate signals and safety for the efficient DL model.

In block 524, the system processes sensor data 1 with the adjusted AV simulation to produce cloud intermediate signals and safety. This yields intermediate signals and safety for the bit accurate DL model.

In block 528, the system calculates a delta between the intermediate signals and safety for the efficient model versus the bit accurate model. The delta allows the system to calculate a total score based on the compute cost and simulation accuracy score for the adjustment. The total cost may be a sum of compute cost and simulation accuracy score costs. This came the simulation accuracy score cost may be expressed as a function of the simulation accuracy score, where ƒ(x)=A*e^{Bx}, where A and B are fit based on an estimated costs of having an incorrect accuracy score. The cost function may be expressed as ƒ(x)={∞, x<threshold, 0, x≥threshold}. The threshold may be set based on the minimum required accuracy score, or in other words, based on a threshold for accuracy. In some cases, no efficient model with an accuracy below the threshold may be used.

The system may iterate over a number of fidelity options, performing the operations of blocks 504-528. This provides cost data for a number of efficient models with their given fidelity values.

In block 532, based upon running numerous efficient models with different fidelities, the system may select a preferred adjustment strategy, which may be expressed as the most nearly optimal efficient model for the current simulation conditions and compute cost and availability. Once the appropriate efficient model is selected, the system may run a large number of simulations on the efficient model to train the DL model for use on the real DSP hardware.

In block 596, the method is done.

FIG. 6 is a block diagram of a hardware platform 600. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Hardware platform 600 may provide a suitable structure for controller 104 of FIG. 1, as well as for AV controller 200 of FIG. 2, elements of FIG. 3, and other computing elements illustrated throughout this specification, including elements external to AV 102. Depending on the embodiment, elements of hardware platform 600 may be omitted, and other elements may be included.

Hardware platform 600 is configured to provide a computing device. In various embodiments, a “computing device” may be or comprise, by way of non-limiting example, a computer, system on a chip (SoC), workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 600 is arranged in a point-to-point (PtP) configuration. This PtP configuration is popular for personal computer (PC) and server-type devices, although it is not so limited, and any other bus type may be used. The PtP configuration may be an internal device bus that is separate from CAN bus 170 of FIG. 1, although in some embodiments they may interconnect with one another.

Hardware platform 600 is an example of a platform that may be used to implement embodiments of the teachings of this specification. For example, instructions could be stored in storage 650. Instructions could also be transmitted to the hardware platform in an ethereal form, such as via a network interface, or retrieved from another source via any suitable interconnect. Once received (from any source), the instructions may be loaded into memory 604, and may then be executed by one or more processor 602 to provide elements such as an operating system 606, operational agents 608, or data 612.

Hardware platform 600 may include several processors 602. For simplicity and clarity, only processors PROC0 602-1 and PROC1 602-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 602 may be any type of processor and may communicatively couple to chipset 616 via, for example, PtP interfaces. Chipset 616 may also exchange data with other elements. In alternative embodiments, any or all of the PtP links illustrated in FIG. 6 could be implemented as any type of bus, or other configuration rather than a PtP link. In various embodiments, chipset 616 may reside on the same die or package as a processor 602 or on one or more different dies or packages. Each chipset may support any suitable number of processors 602. A chipset 616 (which may be a chipset, uncore, Northbridge, Southbridge, or other suitable logic and circuitry) may also include one or more controllers to couple other components to one or more CPUs.

Two memories, 604-1 and 604-2 are shown, connected to PROC0 602-1 and PROC1 602-2, respectively. As an example, each processor is shown connected to its memory in a direct memory access (DMA) configuration, though other memory architectures are possible, including ones in which memory 604 communicates with a processor 602 via a bus. For example, some memories may be connected via a system bus, or in a data center, memory may be accessible in a remote DMA (RDMA) configuration.

Memory 604 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 604 may be used for short, medium, and/or long-term storage. Memory 604 may store any suitable data or information utilized by platform logic. In some embodiments, memory 604 may also comprise storage for instructions that may be executed by the cores of processors 602 or other processing elements (e.g., logic resident on chipsets 616) to provide functionality.

In certain embodiments, memory 604 may comprise a relatively low-latency volatile main memory, while storage 650 may comprise a relatively higher-latency nonvolatile memory. However, memory 604 and storage 650 need not be physically separate devices, and in some examples may simply represent a logical separation of function (if there is any separation at all). It should also be noted that although DMA is disclosed by way of non-limiting example, DMA is not the only protocol consistent with this specification, and that other memory architectures are available.

Certain computing devices provide main memory 604 and storage 650, for example, in a single physical memory device, and in other cases, memory 604 and/or storage 650 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Chipset 616 may be in communication with a bus 628 via an interface circuit. Bus 628 may have one or more devices that communicate over it, such as a bus bridge 632, I/O devices 635, accelerators 646, and communication devices 640, by way of non-limiting example. In general terms, the elements of hardware platform 600 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and non-limiting example.

Communication devices 640 can broadly include any communication not covered by a network interface and the various I/O devices described herein. This may include, for example, various universal serial bus (USB), FireWire, Lightning, or other serial or parallel devices that provide communications. In a particular example, communication device 640 may be used to stream and/or receive data within a CAN. For some use cases, data may be streamed using UDP, which is unidirectional and lacks error correction. UDP may be appropriate for cases where latency and overhead are at a higher premium than error correction. If bi-directional and/or error corrected communication are desired, then a different protocol, such as TCP may be preferred.

I/O devices 635 may be configured to interface with any auxiliary device that connects to hardware platform 600 but that is not necessarily a part of the core architecture of hardware platform 600. A peripheral may be operable to provide extended functionality to hardware platform 600 and may or may not be wholly dependent on hardware platform 600. In some cases, a peripheral may itself be a. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of non-limiting example.

Bus bridge 632 may be in communication with other devices such as a keyboard/mouse 638 (or other input devices such as a touch screen, trackball, etc.), communication devices 640 (such as modems, network interface devices, peripheral interfaces such as PCI or PCIe, or other types of communication devices that may communicate through a network), and/or accelerators 646. In alternative embodiments, any portions of the bus architectures could be implemented with one or more PtP links.

Operating system 606 may be, for example, Microsoft Windows, Linux, UNIX, Mac OS X, iOS, MS-DOS, or an embedded or real-time operating system (including embedded or real-time flavors of the foregoing). For real-time systems such as an AV, various forms of QNX are popular. In some embodiments, a hardware platform 600 may function as a host platform for one or more guest systems that invoke application (e.g., operational agents 608).

Operational agents 608 may include one or more computing engines that may include one or more non-transitory computer-readable mediums having stored thereon executable instructions operable to instruct a processor to provide operational functions. At an appropriate time, such as upon booting hardware platform 600 or upon a command from operating system 606 or a user or security administrator, a processor 602 may retrieve a copy of the operational agent (or software portions thereof) from storage 650 and load it into memory 604. Processor 602 may then iteratively execute the instructions of operational agents 608 to provide the desired methods or functions.

There are described throughout this specification various engines, modules, agents, servers, or functions. Each of these may include any combination of one or more logic elements of similar or dissimilar species, operable for and configured to perform one or more methods provided by the engine. In some cases, the engine may be or include a special integrated circuit designed to carry out a method or a part thereof, an FPGA programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of non-limiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language. These may be used with any compatible operating systems or operating environments. Hardware elements may be designed manually, or with a hardware description language. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

Communication devices 640 may communicatively couple hardware platform 600 to a wired or wireless network or fabric. A “network,” as used throughout this specification, may include any communicative platform operable to exchange data or information within or between computing devices, including any of the protocols discussed in connection with FIG. 1 above. A network interface may include one or more physical ports that may couple to a cable (e.g., an Ethernet cable, other cable, or waveguide), or a wireless transceiver.

In some cases, some or all of the components of hardware platform 600 may be virtualized, in particular the processor(s) and memory. For example, a virtualized environment may run on OS 606, or OS 606 could be replaced with a hypervisor or virtual machine manager. In this configuration, a virtual machine running on hardware platform 600 may virtualize workloads. A virtual machine in this configuration may perform essentially all the functions of a physical hardware platform.

In a general sense, any suitably configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 6 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in ASICs, FPGAs, and other semiconductor chips.

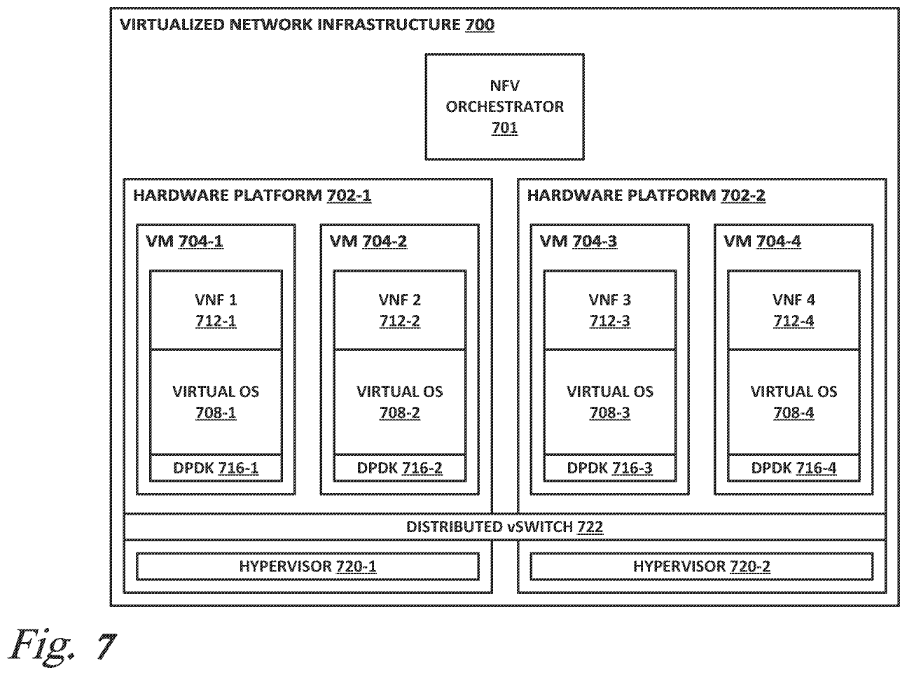

FIG. 7 is a block diagram of an NFV infrastructure 700. NFV is an example of virtualization, and the virtualization infrastructure here can also be used to realize traditional virtual machines (VMs). Various functions described above may be realized as VMs, such as for example validation architecture 302, custom testbed 320, or reconciliation service 318 of FIG. 3 above.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 700. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 7, an NFV orchestrator 701 may manage several VNFs 712 running on an NFVI 700. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 701 a valuable system resource. Note that NFV orchestrator 701 may provide a browser-based or graphical configuration interface, and in some embodiments may be integrated with SDN orchestration functions.

Note that NFV orchestrator 701 itself may be virtualized (rather than a special-purpose hardware appliance). NFV orchestrator 701 may be integrated within an existing SDN system, wherein an operations support system (OSS) manages the SDN. This may interact with cloud resource management systems (e.g., OpenStack) to provide NFV orchestration. An NFVI 700 may include the hardware, software, and other infrastructure to enable VNFs to run. This may include a hardware platform 702 on which one or more VMs 704 may run. For example, hardware platform 702-1 in this example runs VMs 704-1 and 704-2. Hardware platform 702-2 runs VMs 704-3 and 704-4. Each hardware platform 702 may include a respective hypervisor 720, virtual machine manager (VMM), or similar function, which may include and run on a native (bare metal) operating system, which may be minimal so as to consume very few resources. For example, hardware platform 702-1 has hypervisor 720-1, and hardware platform 702-2 has hypervisor 720-2.

Hardware platforms 702 may be or comprise a rack or several racks of blade or slot servers (including, e.g., processors, memory, and storage), one or more data centers, other hardware resources distributed across one or more geographic locations, hardware switches, or network interfaces. An NFVI 700 may also include the software architecture that enables hypervisors to run and be managed by NFV orchestrator 701.

Running on NFVI 700 are VMs 704, each of which in this example is a VNF providing a virtual service appliance. Each VM 704 in this example includes an instance of the Data Plane Development Kit (DPDK) 716, a virtual operating system 708, and an application providing the VNF 712. For example, VM 704-1 has virtual OS 708-1, DPDK 716-1, and VNF 712-1. VM 704-2 has virtual OS 708-2, DPDK 716-2, and VNF 712-2. VM 704-3 has virtual OS 708-3, DPDK 716-3, and VNF 712-3. VM 704-4 has virtual OS 708-4, DPDK 716-4, and VNF 712-4.

Virtualized network functions could include, as non-limiting and illustrative examples, firewalls, intrusion detection systems, load balancers, routers, session border controllers, DPI services, network address translation (NAT) modules, or call security association.

The illustration of FIG. 7 shows that a number of VNFs 704 have been provisioned and exist within NFVI 700. This FIGURE does not necessarily illustrate any relationship between the VNFs and the larger network, or the packet flows that NFVI 700 may employ.

The illustrated DPDK instances 716 provide a set of highly-optimized libraries for communicating across a virtual switch (vSwitch) 722. Like VMs 704, vSwitch 722 is provisioned and allocated by a hypervisor 720. The hypervisor uses a network interface to connect the hardware platform to the data center fabric (e.g., a host fabric interface (HFI)). This HFI may be shared by all VMs 704 running on a hardware platform 702. Thus, a vSwitch may be allocated to switch traffic between VMs 704. The vSwitch may be a pure software vSwitch (e.g., a shared memory vSwitch), which may be optimized so that data are not moved between memory locations, but rather, the data may stay in one place, and pointers may be passed between VMs 704 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 722 is illustrated, wherein vSwitch 722 is shared between two or more physical hardware platforms 702.

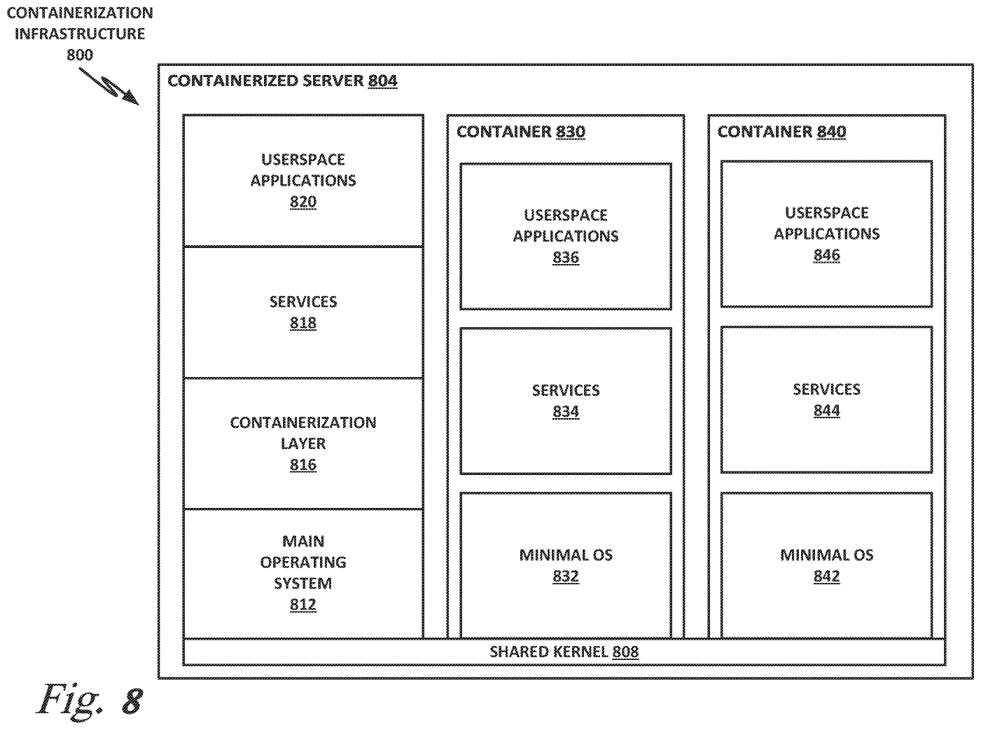

FIG. 8 is a block diagram of selected elements of a containerization infrastructure 800. Like virtualization, containerization is a popular form of providing a guest infrastructure. Various functions described herein may be containerized, such as validation architecture 302, custom testbed 320, and reconciliation service 318 of FIG. 3 above.

Containerization infrastructure 800 runs on a hardware platform such as containerized server 804. Containerized server 804 may provide processors, memory, one or more network interfaces, accelerators, and/or other hardware resources.

Running on containerized server 804 is a shared kernel 808. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 808 is main operating system 812. Commonly, main operating system 812 is a Unix or Linux-based operating system, although containerization infrastructure is also available for other types of systems, including Microsoft Windows systems and Macintosh systems. Running on top of main operating system 812 is a containerization layer 816. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 812 may also provide services 818, which provide services and interprocess communication to userspace applications 820.

Services 818 and userspace applications 820 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 812, they inherit the same file and resource access permissions as those provided by shared kernel 808. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 804, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 804).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors— provide such near-native performance that this advantage may not always be realized.

In this example, containerized server 804 hosts two containers, namely container 830 and container 840.

Container 830 may include a minimal operating system 832 that runs on top of shared kernel 808. Note that a minimal operating system is provided as an illustrative example, and is not mandatory. In fact, container 830 may perform as full an operating system as is necessary or desirable. Minimal operating system 832 is used here as an example simply to illustrate that in common practice, the minimal operating system necessary to support the function of the container (which in common practice, is a single or monolithic function) is provided.

On top of minimal operating system 832, container 830 may provide one or more services 834. Finally, on top of services 834, container 830 may also provide userspace applications 836, as necessary.

Container 840 may include a minimal operating system 842 that runs on top of shared kernel 808. Note that a minimal operating system is provided as an illustrative example, and is not mandatory. In fact, container 840 may perform as full an operating system as is necessary or desirable. Minimal operating system 842 is used here as an example simply to illustrate that in common practice, the minimal operating system necessary to support the function of the container (which in common practice, is a single or monolithic function) is provided.

On top of minimal operating system 842, container 840 may provide one or more services 844. Finally, on top of services 844, container 840 may also provide userspace applications 846, as necessary.

Using containerization layer 816, containerized server 804 may run discrete containers, each one providing the minimal operating system and/or services necessary to provide a particular function. For example, containerized server 804 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

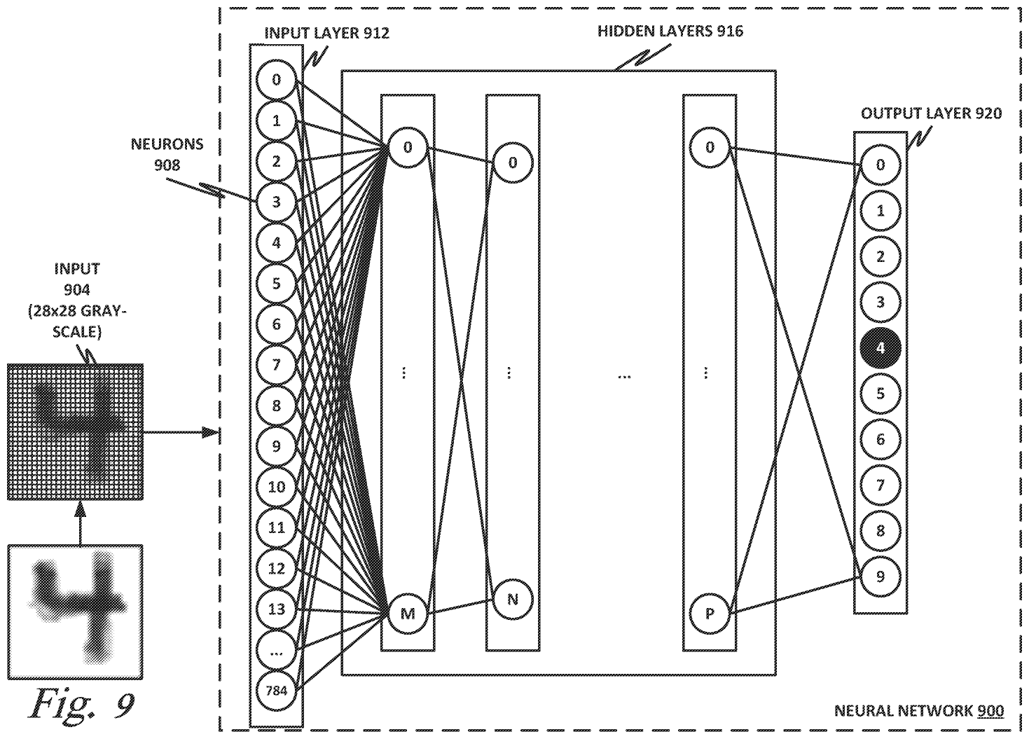

FIGS. 9-11 illustrate selected elements of an AI system or architecture. In these FIGURES, an elementary neural network is used as a representative embodiment of an AI or machine learning architecture or engine. This should be understood to be a non-limiting example, and other machine learning or AI architectures are available, including for example symbolic learning, robotics, computer vision, pattern recognition, statistical learning, speech recognition, natural language processing, DL, convolutional neural networks, recurrent neural networks, object recognition and/or others.

In particular, any of the machine learning and/or DL models discussed herein (e.g., DL model 224 of FIG. 2, and DL models 308 and 324 of FIG. 3) may be provided by an AI system that works conceptually as illustrated. It should be noted that FIGS. 9-11 below provide only a basic and illustrative structure for the DL models. In practice, the models may include features and operations different from and/or in addition to those illustrated herein. Many variations, deviations, and methods are known in the art of deep learning, and the model illustrated here is intended to stand as an illustrative example that represents all known DL models as a class.

FIG. 9 illustrates machine learning according to a “textbook” problem with real-world applications. In this case, a neural network 900 is tasked with recognizing characters. To simplify the description, neural network 900 is tasked only with recognizing single digits in the range of 0 through 9. These are provided as an input image 904. In this example, input image 904 is a 28×28-pixel 8-bit grayscale image. In other words, input image 904 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 900 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other AI architecture, to meet the demands of a particular problem. Indeed, the architecture here is sometimes referred to as the “Hello World” problem of machine learning, and is provided as but one example of how the machine learning or AI functions of the present specification could be implemented.

In this case, neural network 900 includes an input layer 912 and an output layer 920. In principle, input layer 912 receives an input such as input image 904, and at output layer 920, neural network 900 “lights up” a perceptron that indicates which character neural network 900 thinks is represented by input image 904.

Between input layer 912 and output layer 920 are some number of hidden layers 916. The number of hidden layers 916 will depend on the problem to be solved, the available compute resources, and other design factors. In general, the more hidden layers 916, and the more neurons per hidden layer, the more accurate the neural network 900 may become. However, adding hidden layers and neurons also increases the complexity of the neural network, and its demand on compute resources. Thus, some design skill is required to determine the appropriate number of hidden layers 916, and how many neurons are to be represented in each hidden layer 916.

Input layer 912 includes, in this example, 784 “neurons” 908. Each neuron of input layer 912 receives information from a single pixel of input image 904. Because input image 904 is a 28×28 grayscale image, it has 784 pixels. Thus, each neuron in input layer 912 holds 8 bits of information, taken from a pixel of input layer 904. This 8-bit value is the “activation” value for that neuron.

Each neuron in input layer 912 has a connection to each neuron in the first hidden layer in the network. In this example, the first hidden layer has neurons labeled 0 through M. Each of the M+1 neurons is connected to all 784 neurons in input layer 912. Each neuron in hidden layer 916 includes a kernel or transfer function, which is described in greater detail below. The kernel or transfer function determines how much “weight” to assign each connection from input layer 912. In other words, a neuron in hidden layer 916 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 916, until they reach the last layer, which has P+1 neurons labeled 0 through P. Each of these P+1 neurons has a connection to each neuron in output layer 920. Output layer 920 includes a number of neurons known as perceptrons that compute an activation value based on their weighted connections to each neuron in the last hidden layer 916. The final activation value computed at output layer 920 may be thought of as a “probability” that input image 904 is the value represented by the perceptron. For example, if neural network 900 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 916 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (a) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

α₀⁽¹⁾=σ(w₀α₀⁽⁰⁾+w₁α₁⁽⁰⁾+w₇₈₃α₇₈₃⁽⁰⁾+b)

In this case, it is assumed that layer 0 (input layer 912) has 784 neurons. Where the previous layer has “n” neurons, the function can be generalized as:

α₀⁽¹⁾=σ(w₀α₀⁽⁰⁾+w₁α₁⁽⁰⁾+ . . . (wₙαₙ⁽⁰⁾+b)

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$$\\ {a}^{( 1 )} = σ ( [ \begin{matrix}{w}_{0 , 0} & ⋯ & {w}_{0 , n} \\ ⋮ & ⋱ & ⋮ \\ {w}_{( k , 0 )} & ⋯ & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

a⁽¹⁾=σ(Wa⁽⁰⁾+b)

Neural connections and activation values are propagated throughout the hidden layers 916 of the network in this way, until the network reaches output layer 920. At output layer 920, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 920 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as accounting, information technology (IT), and human resources. On the other hand, the activation values for perceptrons for legal, manufacturing, and shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights and biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,000 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

Wherein w is a vector containing all of the parameters (weights and biases) in the network. The minimum (absolute and/or local) can then be represented as a trivial calculus problem, namely:

$$\\ \frac{dC}{dw} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolutel minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

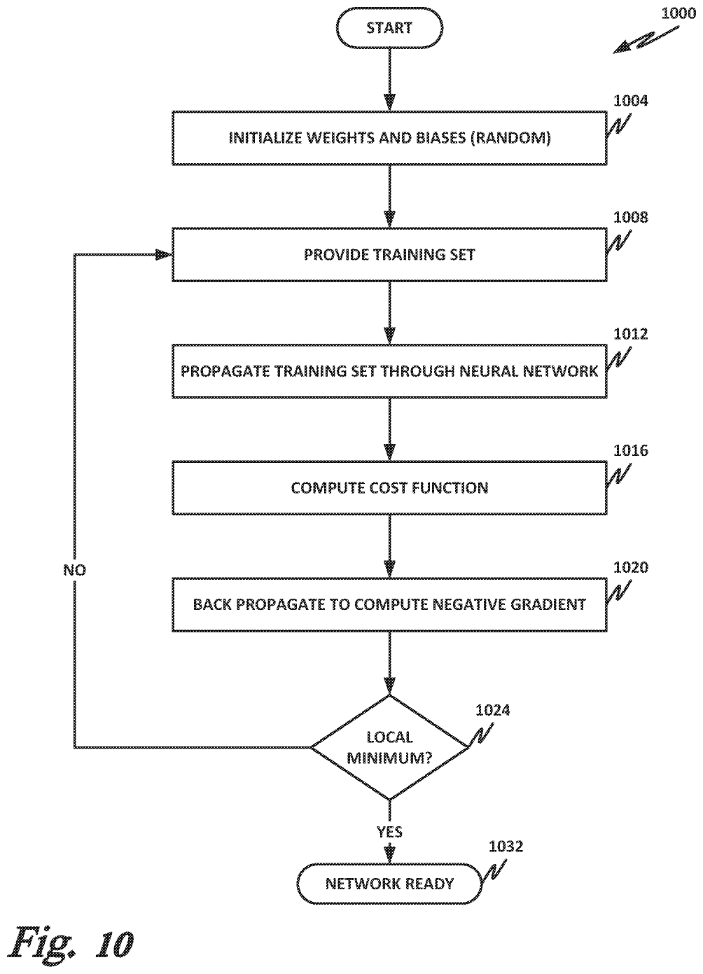

FIG. 10 is a flowchart of a method 1000. Method 1000 may be used to train a neural network, such as neural network 900 of FIG. 9.

In block 1004, the network is initialized. Initially, neural network 900 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1008, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1008, the initial training set is provided to the neural network. Alternatively, the full training set could be used in each iteration.

In block 1012, the training data are propagated through the neural network. Because the initial values are random, and are therefore essentially garbage, it is expected that the output will also be a garbage value. In other words, if neural network 900 of FIG. 9 has not been trained, when input image 904 is fed into the neural network, it is not expected with the first training set that output layer 920 will light up perceptron 4. Rather, the perceptrons may have values that are all over the map, with no clear winner, and with very little relation to the number 4.

In block 1016, a cost function is computed as described above. For example, in neural network 900, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1020, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1024, the system determines whether it has reached a local minimum (e.g., whether the gradient has reached 0 within the threshold). If the local minimum has not been reached, then the neural network has not been adequately trained, and control returns to block 1008 with a new training set. The training sequence continues until, in block 1024, a local minimum has been reached.

Now that a local minimum has been reached and the corrections have been back-propagated, in block 1032, the neural network is ready.

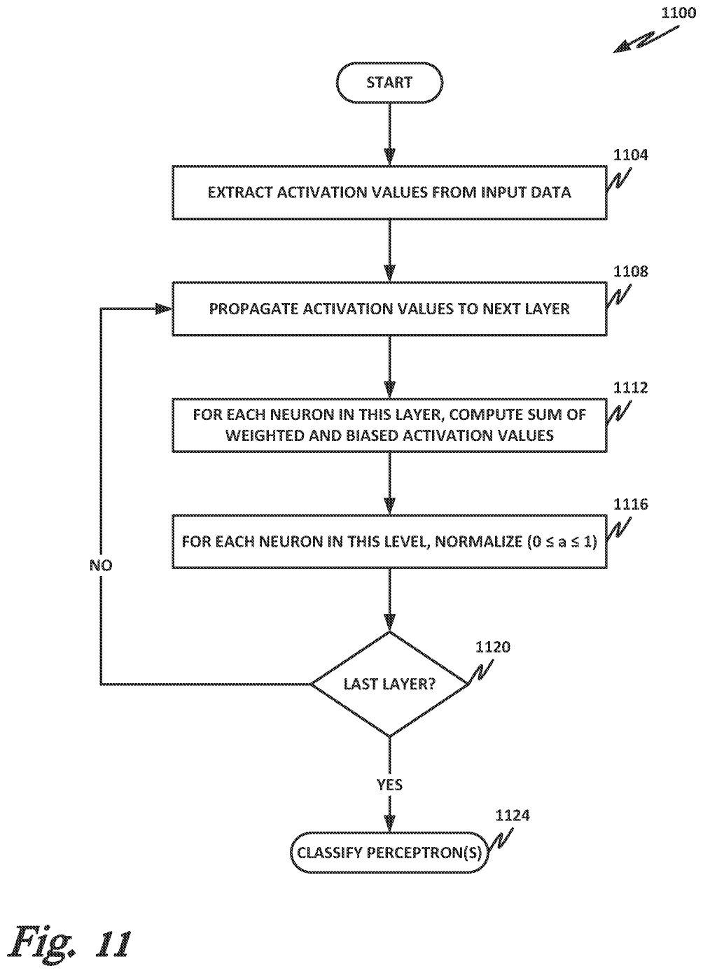

FIG. 11 is a flowchart of a method 1100. Method 1100 illustrates a method of using a neural network, such as network 900 of FIG. 9, to classify an object.

In block 1104, the network extracts the activation values from the input data. For example, in the example of FIG. 9, each pixel in input image 904 is assigned as an activation value to a neuron 908 in input layer 912.

In block 1108, the network propagates the activation values from the current layer to the next layer in the neural network. For example, after activation values have been extracted from the input image, those values may be propagated to the first hidden layer of the network.

In block 1112, for each neuron in the current layer, the neuron computes a sum of weighted and biased activation values received from each neuron in the previous layer. For example, in the illustration of FIG. 9, neuron 0 of the first hidden layer is connected to each neuron in input layer 912. A sum of weighted values is computed from those activation values, and a bias is applied.

In block 1116, for each neuron in the current layer, the network normalizes the activation values by applying a function such as sigmoid, ReLU, or some other function.

In decision block 1120, the network determines whether it has reached the last layer in the network. If this is not the last layer, then control passes back to block 1108, where the activation values in this layer are propagated to the next layer.

Returning to decision block 1120, If the network is at the last layer, then the neurons in this layer are perceptrons that provide final output values for the object. In terminal 1124, the perceptrons are classified and used as output values.

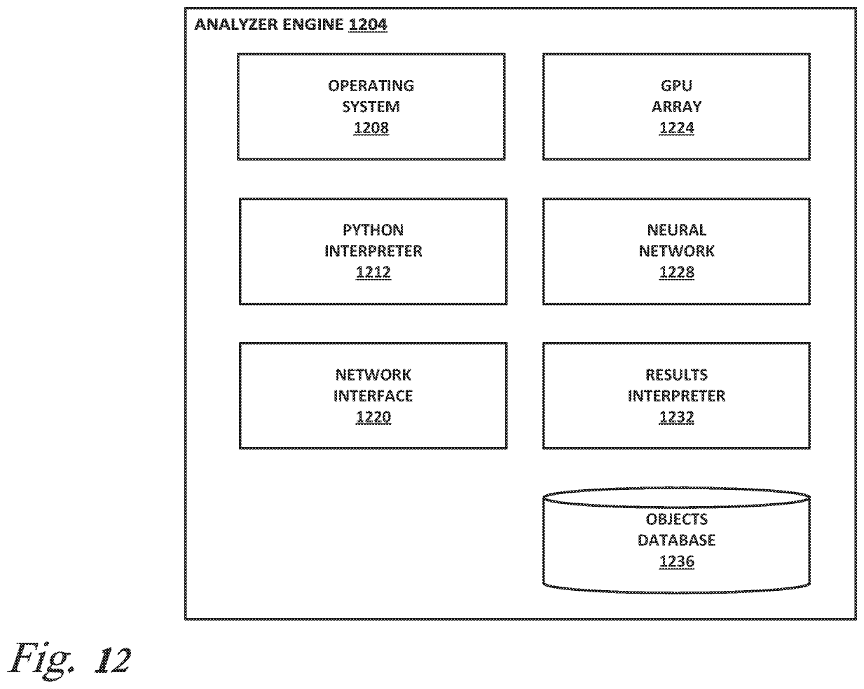

FIG. 12 is a block diagram illustrating selected elements of an analyzer engine 1204. Analyzer engine 1204 may be configured to provide analysis services, such as via a neural network. FIG. 12 illustrates a platform for providing analysis services. Analysis, such as neural analysis and other machine learning models, may be used in some embodiments to provide one or more features of the present disclosure.

Note that analyzer engine 1204 is illustrated here as a single modular object, but in some cases, different aspects of analyzer engine 1204 could be provided by separate hardware, or by separate guests (e.g., VMs or containers) on a hardware system.

Analyzer engine 1204 includes an operating system 1208. Commonly, operating system 1208 is a Linux operating system, although other operating systems, such as Microsoft Windows, Mac OS X, UNIX, or similar could be used. Analyzer engine 1204 also includes a Python interpreter 1212, which can be used to run Python programs. A Python module known as Numerical Python (NumPy) is often used for neural network analysis. Although this is a popular choice, other non-Python or non-NumPy systems could also be used. For example, the neural network could be implemented in Matrix Laboratory (MATLAB), C, C++, Fortran, R, or some other compiled or interpreted computer language.

GPU array 1224 may include an array of graphics processing units that may be used to carry out the neural network functions of neural network 1228. Note that GPU arrays are a popular choice for this kind of processing, but neural networks can also be implemented in CPUs, or in ASICs or FPGAs that are specially designed to implement the neural network.

Neural network 1228 includes the actual code for carrying out the neural network, and as mentioned above, is commonly programmed in Python.

Results interpreter 1232 may include logic separate from the neural network functions that can be used to operate on the outputs of the neural network to assign the object for particular classification, perform additional analysis, and/or provide a recommended remedial action.

Objects database 1236 may include a database of known malware objects and their classifications. Neural network 1228 may initially be trained on objects within objects database 1236, and as new objects are identified, objects database 1236 may be updated with the results of additional neural network analysis.

Once final results have been obtained, the results may be sent to an appropriate destination via network interface 1220.

### SELECTED EXAMPLES

Example 1 includes a method of testing/validating a deep learning (DL) model, comprising: running a first version of the DL model on a first hardware platform using a first input set; running a second version of the DL model on a second hardware platform using the first input set, comprising imperfectly emulating the first hardware platform on the second hardware platform; computing an adjustment based at least in part on a difference in results between the first version of the DL model and second version of the DL model; and testing/validating the DL model on the second hardware platform using the adjustment and a plurality of input sets.

Example 2 includes the method of example 1, wherein imperfectly emulating the first hardware platform comprises emulating with less than perfect bit precision.

Example 3 includes the method of example 1, wherein imperfectly emulating the first hardware platform comprises selecting an emulation fidelity from among a plurality of emulation fidelities.

Example 4 includes the method of example 3, wherein the emulation fidelities corresponding to respective different precision, different size of machine learning models, different number of layers, different channel, and/or or filter widths for a machine learning model.

Example 5 includes the method of example 4, wherein a precision for an emulation fidelity is selected from a list of supported precisions for the first or the second hardware platform.

Example 6 includes the method of example 4, further comprising training the DL model with a trainable model that emulates the adjustment.

Example 7 includes the method of example 6, wherein emulating the adjustment comprises injecting noise into intermediate signals of the DL model.

Example 8 includes the method of example 3, further comprising iterating through the plurality of emulation fidelities, and selecting a preferred emulation fidelity for training the DL model.

Example 9 includes the method of example 8, wherein selecting the preferred emulation fidelity comprises accounting for adjustments for the plurality of emulation fidelities.

Example 10 includes the method of example 8, wherein selecting the preferred emulation fidelity comprises accounting for adjustments for the plurality of emulation fidelities and execution costs of the plurality of emulation fidelities.

Example 11 includes the method of example 10, wherein the execution costs comprise transitory execution costs.

Example 12 includes the method of example 1, wherein the first version of the DL model and second version of the DL model have different numbers of layers.

Example 13 includes the method of example 1, wherein the first version of the DL model and second version of the DL model have different numbers of perceptrons.

Example 14 includes the method of example 1, wherein the first version of the DL model and second version of the DL model have different numbers of input layer neurons.

Example 15 includes the method of example 1, wherein the first hardware platform comprises a digital signal processor (DSP) or microcontroller with specialized hardware for providing control of an autonomous vehicle (AV).

Example 16 includes the method of example 1, wherein the first hardware platform comprises a general-purpose microprocessor programmed to simulate a digital signal processor (DSP) or microcontroller with specialized hardware for providing control of an autonomous vehicle (AV) with bitwise accuracy.

Example 17 includes the method of example 1, wherein the first hardware platform comprises a cloud-based service for training the DL model, wherein the cloud-based service is programmed to simulate a digital signal processor (DSP) or microcontroller with specialized hardware for providing control of an autonomous vehicle (AV).

Example 18 includes a method of an apparatus comprising means for performing the method of any of examples 1-17.

Example 19 includes the apparatus of example 18, wherein the means for performing the method comprise a processor and a memory.

Example 20 includes the apparatus of example 19, wherein the memory comprises machine-readable instructions that, when executed, cause the apparatus to perform the method of any of examples 1-17.

Example 21 includes the apparatus of any of examples 18-20, wherein the apparatus is a computing system.

Example 22 includes at least one computer-readable medium comprising instructions that, when executed, implement a method or realize an apparatus as described in any of examples 1-21.

Example 23 includes at least one or more non-transitory computer-readable storage media having stored thereon executable instructions to: receive first intermediate signal and safety data from a bitwise accurate version of a deep learning (DL) model; receive second intermediate signal and safety data from an efficient version of the DL model, wherein the efficient version has a fidelity that is not bitwise accurate; compute a correction for the efficient version based at least in part on a delta between the first intermediate signal and safety data and the second intermediate signal and safety data; and train the DL model using the efficient version and the correction.

Example 24 includes one or more non-transitory computer-readable storage media of example 23, wherein the executable instructions are further to select, for the efficient version, an emulation fidelity from among a plurality of emulation fidelities.

Example 25 includes one or more non-transitory computer-readable storage media of example 24, further comprising iterating through the plurality of emulation fidelities, and selecting a preferred emulation fidelity for training the DL model.

Example 26 includes one or more non-transitory computer-readable storage media of example 25, wherein selecting the preferred emulation fidelity comprises accounting for corrections for the plurality of emulation fidelities.

Example 27 includes one or more non-transitory computer-readable storage media of example 25, wherein selecting the preferred emulation fidelity comprises accounting for corrections for the plurality of emulation fidelities and execution costs of the emulation fidelities.

Example 28 includes one or more non-transitory computer-readable storage media of example 27, wherein the execution costs comprise transitory execution costs.

Example 29 includes one or more non-transitory computer-readable storage media of example 23, wherein the bitwise accurate version of the DL model and the efficient version of the DL model have different numbers of layers.

Example 30 includes one or more non-transitory computer-readable storage media of example 23, wherein the bitwise accurate version of the DL model and the efficient version of the DL model have different numbers of perceptions.

Example 31 includes one or more non-transitory computer-readable storage media of example 23, wherein the bitwise accurate version of the DL model and efficient version of the DL model have different numbers of input layer neurons.

Example 32 includes one or more non-transitory computer-readable storage media of example 23, wherein the bitwise accurate version was executed on a first hardware platform comprising a digital signal processor (DSP) or microcontroller with specialized hardware for providing control of an autonomous vehicle (AV).

Example 33 includes one or more non-transitory computer-readable storage media of example 23, wherein the bitwise accurate version was executed on a second hardware platform comprising a general-purpose microprocessor.

Example 34 includes one or more non-transitory computer-readable storage media of example 23, wherein the bitwise accurate version was executed on a second hardware platform comprising a cloud-based service for training the DL model.

Example 35 includes a computing ecosystem, comprising: a first hardware platform comprising a first processor and memory programmed to provide a bitwise accurate version of a deep learning (DL) model; a training service comprising a second processor and memory programmed to provide an efficient version of the DL model, wherein the efficient version is not bitwise accurate; a reconciliation service comprising a third processor and memory programmed to compare first intermediate data from the bitwise accurate version to second intermediate data from the efficient version, and compute a correction for the efficient version; and a training service comprising a fourth processor and memory programmed to train the DL model on the efficient version using the correction.

Example 36 includes the computing ecosystem of example 35, wherein imperfectly emulating the first hardware platform comprises emulating with less than perfect bit precision.

Example 37 includes the computing ecosystem of example 35, wherein imperfectly emulating the first hardware platform comprises selecting an emulation fidelity from among a plurality of emulation fidelities.

Example 38 includes the computing ecosystem of example 37, further comprising iterating through the plurality of emulation fidelities, and selecting a preferred emulation fidelity for training the DL model.

Example 39 includes the computing ecosystem of example 38, wherein selecting the preferred emulation fidelity comprises accounting for corrections for the plurality of emulation fidelities.

Example 40 includes the computing ecosystem of example 38, wherein selecting the preferred emulation fidelity comprises accounting for corrections for the plurality of emulation fidelities and execution costs of the emulation fidelities.

Example 41 includes the computing ecosystem of example 40, wherein the execution costs comprise transitory execution costs.

Example 42 includes the computing ecosystem of example 35, wherein the bitwise accurate version of the DL model and efficient version of the DL model have different numbers of layers.

Example 43 includes the computing ecosystem of example 35, wherein the bitwise accurate version of the DL model and efficient version of the DL model have different numbers of perceptions.

Example 44 includes the computing ecosystem of example 35, wherein the bitwise accurate version of the DL model and efficient version of the DL model have different numbers of input layer neurons.

Example 45 includes the computing ecosystem of example 35, wherein the bitwise accurate version was executed on a first hardware platform comprising a digital signal processor (DSP) or microcontroller with specialized hardware for providing control of an autonomous vehicle (AV).

Example 46 includes the computing ecosystem of example 35, wherein the bitwise accurate version was executed on a second hardware platform comprising a general-purpose microprocessor.

Example 47 includes the computing ecosystem of example 35, wherein the bitwise accurate version was executed on a second hardware platform comprising a cloud-based service for training the DL model.

### VARIATIONS AND IMPLEMENTATIONS

As will be appreciated by one skilled in the art, aspects of the present disclosure, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module,” or “system.” In at least some cases, a “circuit” may include both the physical hardware of the circuit, plus any hardware and firmware that programs or configures the circuit. For example, a network circuit may include the physical network interface circuitry, as well as the logic (software and firmware) that provides the functions of a network stack.

Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The foregoing detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While components, arrangements, and/or features are described below in connection with various example embodiments, these are merely examples used to simplify the present disclosure and are not intended to be limiting.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The “means for” in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What is claimed is:

1. A method of validating a deep learning (DL) model, comprising:
running a first version of the DL model on a first hardware platform using a first input set;
running a second version of the DL model on a second hardware platform using the first input set, comprising imperfectly emulating the first hardware platform on the second hardware platform;
computing an adjustment based at least in part on a difference in results between the first version of the DL model and second version of the DL model; and
validating the DL model on the second hardware platform using the adjustment and a plurality of input sets.

2. The method of claim 1, wherein imperfectly emulating the first hardware platform comprises selecting an emulation fidelity from among a plurality of emulation fidelities.

3. The method of claim 2, wherein the emulation fidelities correspond to respective different precision, different size of machine learning models, different number of layers, different channel, and/or or filter widths for a machine learning model.

4. The method of claim 3, wherein a precision for an emulation fidelity is selected from a list of supported precisions for the first or the second hardware platform.

5. The method of claim 1, further comprising training the DL model with a trainable model that emulates the adjustment.

6. The method of claim 5, wherein emulating the adjustment comprises injecting noise into intermediate signals of the DL model.

7. The method of claim 2, further comprising iterating through the plurality of emulation fidelities, and selecting a preferred emulation fidelity for training the DL model.

8. The method of claim 7, wherein selecting the preferred emulation fidelity comprises accounting for adjustments for the plurality of emulation fidelities.

9. The method of claim 7, wherein selecting the preferred emulation fidelity comprises accounting for adjustments for the plurality of emulation fidelities and execution costs of the plurality of emulation fidelities.

10. The method of claim 9, wherein the execution costs comprise transitory execution costs.

11. The method of claim 1, wherein the first version of the DL model and second version of the DL model have different numbers of layers, perceptrons, or input layer neurons.

12. The method of claim 1, wherein the first hardware platform comprises a digital signal processor (DSP) or microcontroller with specialized hardware for providing control of an autonomous vehicle (AV).

13. The method of claim 1, wherein the first hardware platform comprises a general-purpose microprocessor programmed to simulate a digital signal processor (DSP) or microcontroller with specialized hardware for providing control of an autonomous vehicle (AV) with bitwise accuracy.

14. One or more non-transitory computer-readable storage media having stored thereon executable instructions to:
receive first intermediate signal and safety data from a bitwise accurate version of a deep learning (DL) model;
receive second intermediate signal and safety data from an efficient version of the DL model, wherein the efficient version has a fidelity that is not bitwise accurate;
compute a correction for the efficient version based at least in part on a delta between the first intermediate signal and safety data and the second intermediate signal and safety data; and
train the DL model using the efficient version and the correction.

15. The one or more non-transitory computer-readable storage media of claim 14, wherein the executable instructions are further to select, for the efficient version, an emulation fidelity from among a plurality of emulation fidelities.

16. The one or more non-transitory computer-readable storage media of claim 15, further comprising iterating through the plurality of emulation fidelities, and selecting a preferred emulation fidelity for training the DL model.

17. A computing ecosystem, comprising:
a first hardware platform comprising a first processor and memory programmed to provide a bitwise accurate version of a deep learning (DL) model;
a training service comprising a second processor and memory programmed to provide an efficient version of the DL model, wherein the efficient version is not bitwise accurate;
a reconciliation service comprising a third processor and memory programmed to compare first intermediate data from the bitwise accurate version to second intermediate data from the efficient version, and compute a correction for the efficient version; and
a training service comprising a fourth processor and memory programmed to train the DL model on the efficient version using the correction.

18. The computing ecosystem of claim 17, wherein imperfectly emulating the first hardware platform comprises selecting an emulation fidelity from among a plurality of emulation fidelities.

19. The computing ecosystem of claim 18, further comprising iterating through the plurality of emulation fidelities, and selecting a preferred emulation fidelity for training the DL model.

20. The computing ecosystem of claim 19, wherein selecting the preferred emulation fidelity comprises accounting for corrections for the plurality of emulation fidelities.
